(19) United States
(12) Patent Application Publication
(10) Pub. No.: US 2024/0234966 A9
(43) Pub. Date: Jul. 11, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP); Mitsutoshi MORITA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/271,554

(22) PCT Filed: Jan. 6, 2022
(86) PCT No.: PCT/JP2022/000176

§ 371 Date: Jul. 10, 2023

(30) Foreign Application Priority Data
Jan. 19, 2021 (JP) 2021-006349

(51) Int. Cl. H01M 50/519; H01M 50/507; H01M 50/548; H01M 50/583

(52) U.S. Cl. CPC H01M 50/519; H01M 50/507; H01M 50/548; H01M 50/583; H01M 2220/20

(57) ABSTRACT

A wiring module that is attached to a plurality of power storage elements, including: a circuit board; an electric wire; and a protector configured to hold the circuit board and the electric wire, wherein a conductive path is routed on the circuit board, and the conductive path includes a connection land that is electrically connected to an electrode terminal of a power storage element among the plurality of power storage elements, an electric wire land that is connected to one end of the electric wire, and a fuse portion provided between the connection land and the electric wire land.

### TECHNICAL FIELD

The present disclosure relates to a wiring module.

### BACKGROUND ART

Usually, in a high-voltage battery pack used in an electric or hybrid car or the like, many battery cells are stacked and electrically connected to each other in parallel or in series by a wiring module. A busbar assembly disclosed in JP 2019-500736T (Patent Document 1 below) is conventionally known as such a wiring module. The busbar assembly disclosed in Patent Document 1 is a busbar assembly in which an electrode lead protrudes on at least one side, and is attached to a plurality of battery cells stacked on one another, and includes a busbar frame provided with a lead slot through which the electrode lead is passed, and a busbar that is electrically coupled to the electrode lead extending through the lead slot.

### CITATION LIST

### Patent Documents

Patent Document 1: JP 2019-500736T

### SUMMARY OF INVENTION

### Problem to be Solved

However, in the above configuration, the busbar assembly is not provided with a fuse function and thus there are safety concerns. In order to impart a fuse function to the wiring module, it is conceivable to incorporate a circuit board including a fuse into the wiring module, but using a circuit board may increase the manufacturing cost of the wiring module.

### Solution to Problem

A wiring module according to the present disclosure is a wiring module that is attached to a plurality of power storage elements, including: a circuit board; an electric wire; and a protector configured to hold the circuit board and the electric wire, wherein a conductive path is routed on the circuit board, and the conductive path includes a connection land that is electrically connected to an electrode terminal of a power storage element among the plurality of power storage elements, an electric wire land that is connected to one end of the electric wire, and a fuse portion provided between the connection land and the electric wire land.

### Advantageous Effects of Invention

With the present disclosure, it is possible to provide a wiring module that can suppress an increase in the manufacturing cost incurred by imparting a fuse function.

### BRIEF DESCRIPTION OF DRAWINGS

FIG. 1 is a schematic view of a vehicle in which a power storage module according to Embodiment 1 is mounted.

FIG. 2 is a perspective view of the power storage module.

FIG. 3 is a front view of the power storage module.

FIG. 4 is a perspective view of a power storage element.

FIG. 5 is a perspective view of power storage elements.

FIG. 6 is an enlarged front view of the power storage module showing a circuit board.

FIG. 7 is an enlarged perspective view of the power storage module showing a sub-terminal.

FIG. 8 is an enlarged front view of the power storage module showing a second electric wire locked portion including an insulating coating.

FIG. 9 is a cross-sectional view taken along line A-A in FIG. 3.

FIG. 10 is a cross-sectional view taken along line B-B in FIG. 3.

FIG. 11 is a cross-sectional view taken along line C-C in FIG. 6.

FIG. 12 is a cross-sectional view taken along line D-D in FIG. 6.

FIG. 13 is a cross-sectional view taken along line E-E in FIG. 6.

FIG. 14 is a cross-sectional view taken along line F-F in FIG. 6.

FIG. 15 is a cross-sectional view taken along line G-G in FIG. 6.

FIG. 16 is a front view of a power storage module according to Embodiment 2.

FIG. 17 is a perspective view of power storage elements.

FIG. 18 is an enlarged perspective view of the power storage module showing a sub-terminal.

FIG. 19 is an enlarged front view of a power storage module showing a circuit board according to Embodiment 3.

FIG. 20 is an enlarged front view of a power storage module showing a circuit board according to Embodiment 4.

### EMBODIMENTS OF THE INVENTION

### Description of Embodiments of Disclosure

First, embodiments of the present disclosure will be listed and described.

(1) A wiring module according to the present disclosure is a wiring module that is attached to a plurality of power storage elements, including: a circuit board; an electric wire; and a protector configured to hold the circuit board and the electric wire, wherein a conductive path is routed on the circuit board, and the conductive path includes a connection land that is electrically connected to an electrode terminal of a power storage element among the plurality of power storage elements, an electric wire land that is connected to one end of the electric wire, and a fuse portion provided between the connection land and the electric wire land.

With this configuration, the wiring module is provided with the circuit board including the fuse portion, and the electric wire is used together with the circuit board, and thus the amount of circuit boards used can be reduced. Thus, it is possible to suppress an increase in the manufacturing cost of the wiring module while providing the fuse portion in the wiring module.

(2) It is preferable that each of the power storage elements is a laminated battery, and the plurality of power storage elements are provided with a joining portion where the electrode terminals of the adjacent laminated batteries are electrically connected to each other.

With this configuration, there is no need to provide a member for connecting adjacent electrode terminals of the power storage elements on the wiring module.

(3) It is preferable that the wiring module further includes a sub-terminal that electrically connects the electrode terminal and the connection land to each other.

With this configuration, the electrode terminal and the connection land can be easily electrically connected to each other. Also, the amount of circuit boards used can be reduced.

(4) It is preferable that the wiring module further includes two busbars each configured to connect a corresponding connection land to a corresponding one of the electrode terminals that are provided at two end portions of the plurality of power storage elements and do not form the joining portion.

With this configuration, the positive and negative electrodes of the power storage elements as a whole can be formed using the busbars.

(5) It is preferable that the protector includes an electric wire locking portion configured to lock the electric wire.

With this configuration, the electric wire can be locked to the protector.

(6) It is preferable that two of the electric wire locking portions are provided on each electric wire land, and are disposed on two sides of the electric wire land.

With this configuration, the electric wire and the electric wire lands can be easily electrically connected to each other.

(7) It is preferable that the circuit board includes a locked portion, and the protector includes a board locking portion configured to lock the locked portion.

With this configuration, the circuit board can be locked to the protector.

(8) It is preferable that the wiring module further includes a connector connected to another end of the electric wire, wherein the connector is held by the protector.

With this configuration, electric signals from the power storage elements can be transmitted to an external device via the connector.

(9) It is preferable that the fuse portion is constituted by a chip fuse that is soldered to the conductive path of the circuit board.

With this configuration, the chip fuse melts when an overcurrent flows through the conductive path, and thus the conductive path can be protected from the overcurrent.

(10) It is preferable that the circuit board is a flexible printed circuit board, and the fuse portion is constituted by a pattern fuse.

With this configuration, the fuse portion can be formed in the process of manufacturing the flexible printed circuit board.

(11) It is preferable that the circuit board is provided with more than one of each of the connection land, the electric wire land, and the fuse portion.

With this configuration, the number of circuit boards used for the wiring module can be reduced, and thus the assembly workability of the wiring module can be improved.

(12) It is preferable that the wiring module is attached to the front and rear of the plurality of power storage elements that are elongated in a front-rear direction, and includes the electric wire routed extending in the front-rear direction.

With this configuration, the wiring module includes the electric wire routed extending in the front-rear direction, and thus the manufacturing cost of the wiring module can be reduced.

(13) The above wiring module is a vehicle wiring module to be used mounted in a vehicle.

### DETAILED DESCRIPTION OF EMBODIMENTS OF DISCLOSURE

Embodiments of the present disclosure are described below. The present disclosure is not limited to these examples, but is indicated by the claims, and all changes that come within the meaning and range of equivalency of the claims are intended to be embraced therein.

### Embodiment 1

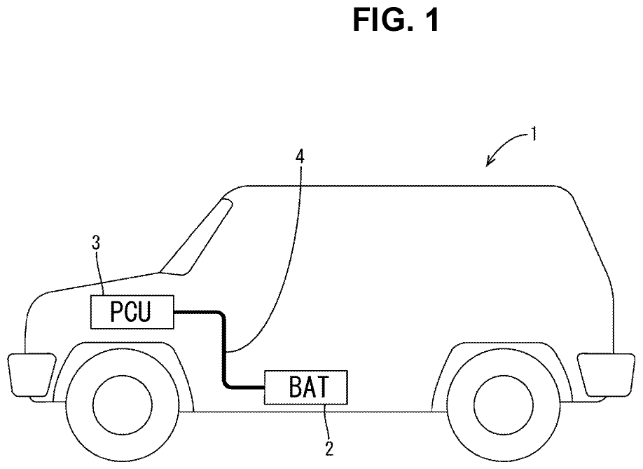

Embodiment 1 of the present disclosure will be described with reference to FIGS. 1 to 15. A power storage module 10 provided with wiring modules 20 of the present embodiment is, for example, applied to a power storage pack 2 mounted in a vehicle 1, as shown in FIG. 1. The power storage pack 2 is mounted in the vehicle 1, which is an electric car, a hybrid car, or the like, and is used as a driving source of the vehicle 1. In the following description, reference numerals may only be given to some of the same members and omitted from the other members.

As shown in FIG. 1, the power storage pack 2 is installed near the center of the vehicle 1. A power control unit (PCU) 3 is installed toward the front of the vehicle 1. The power storage pack 2 and the PCU 3 are connected to each other by a wire harness 4. The power storage pack 2 and the wire harness 4 are connected to each other by a connector (not shown). The power storage pack 2 includes the power storage module 10 that is provided with power storage elements 11. The power storage module 10 (and the wiring modules 20) can be mounted in any orientation, but below, the direction indicated by the Z arrow will be referred to as the upward direction, the direction indicated by the X arrow will be referred to as the forward direction, and the direction indicated by the Y arrow will be referred to as the left direction, excluding FIG. 1.

### Power Storage Elements and Electrode Terminals

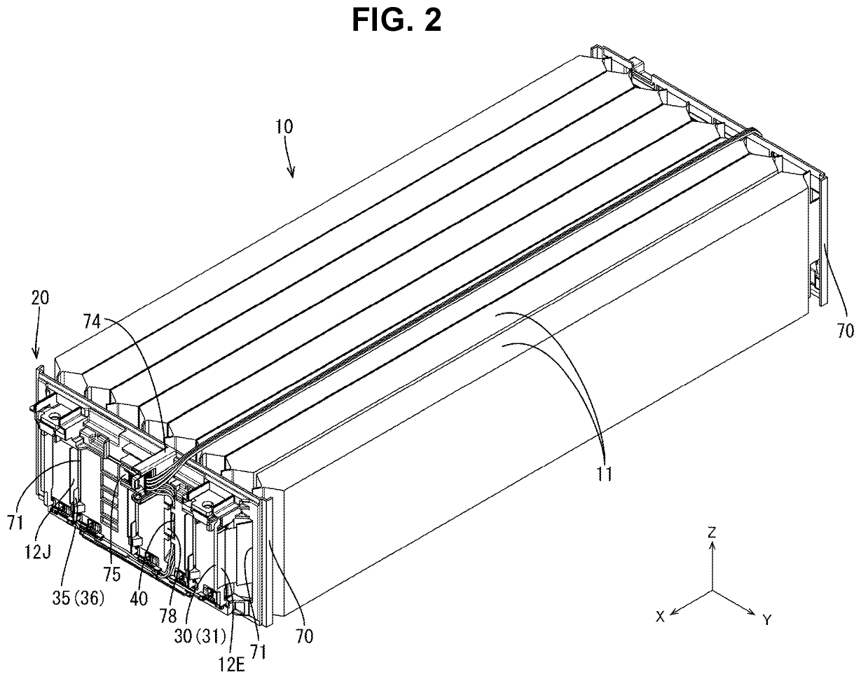

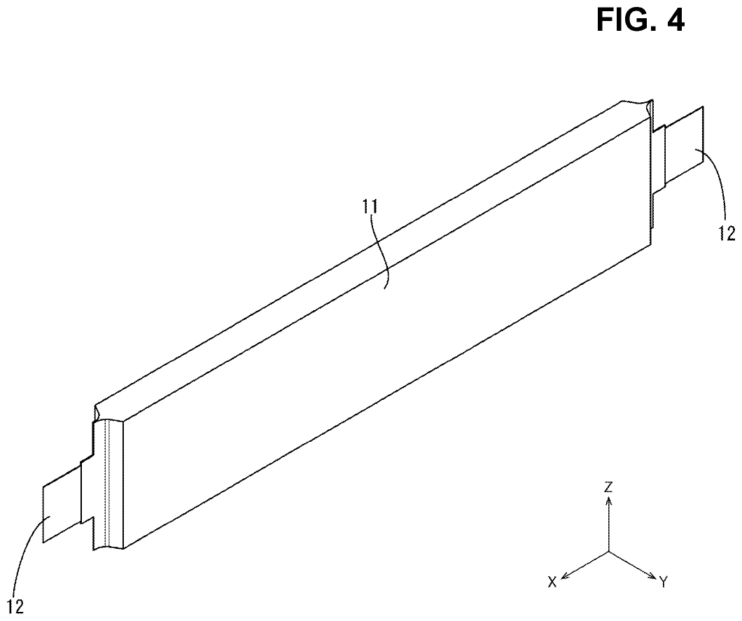

As shown in FIG. 2, the power storage module 10 includes the power storage elements 11 arranged side-by-side in the left-right direction, and the wiring modules 20 attached to the front and rear sides of the power storage elements 11. As shown in FIG. 4, each power storage element 11 of the present embodiment is a laminated battery. The power storage element 11 has a shape that is elongated in the front-rear direction and is flat in the left-right direction. Each power storage element 11 contains power storing elements (not shown). Two electrode terminals 12 are respectively provided on two sides of the power storage element 11 in the front-rear direction so as to protrude in opposite directions. Each pair of electrode terminals 12 include plate-shaped terminals that have opposing polarities.

### Joining Portion

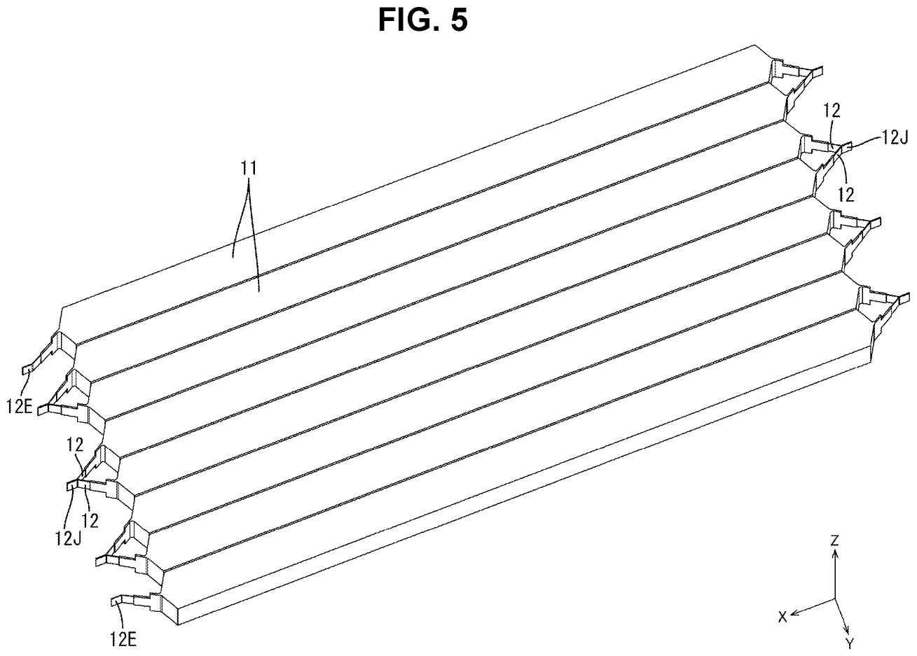

As shown in FIG. 5, the power storage elements 11 according to Embodiment 1 are provided with joining portions 12J where adjacent electrode terminals 12 are electrically connected to each other. Specifically, adjacent electrode terminals 12 are bent in advance so as to approach each other, and are overlapped with each other to be joined through laser welding. The joining portions 12J are disposed parallel to left and right side surfaces of the power storage elements 11. The electrode terminals 12 that are disposed at two end portions of the power storage elements 11 and do not form a joining portion 12J are end portion electrode terminals 12E. The end portion electrode terminals 12E are disposed protruding forward. The end portion electrode terminals 12E form a positive or negative electrode of the power storage elements 11 as a whole.

### Wiring Module

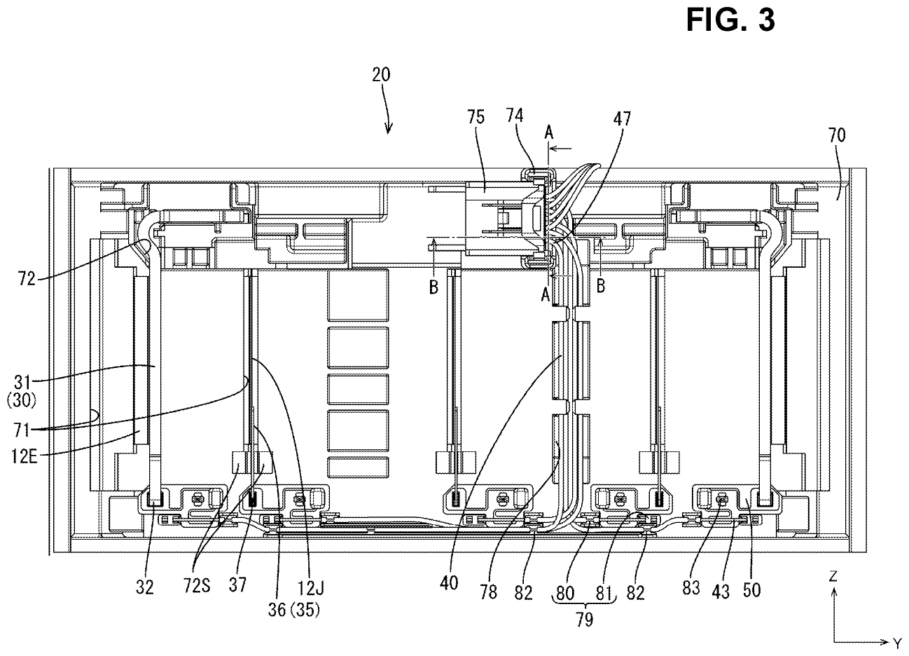

As shown in FIG. 3, the wiring module 20 of the present embodiment includes sub-terminals 35 connected to the joining portions 12J, busbars 30 connected to the end portion electrode terminals 12E, electric wires 40, circuit boards 50 to which a sub-terminal 35 or a busbar 30 and one end 43 of an electric wire 40 is connected, and a protector 70 that holds the sub-terminals 35, the busbars 30, the electric wires 40, and the circuit boards 50. As shown in FIG. 2, the wiring modules 20 are attached to the front and rear sides of the power storage elements 11. Below, the configuration of the wiring module 20 disposed on the front side of the power storage elements 11 will be described in detail. While not shown, apart from not including the busbars 30, the wiring module 20 disposed on the rear side of the power storage elements 11 has the same configuration as the wiring module 20 disposed on the front side of the power storage elements 11.

### Protector

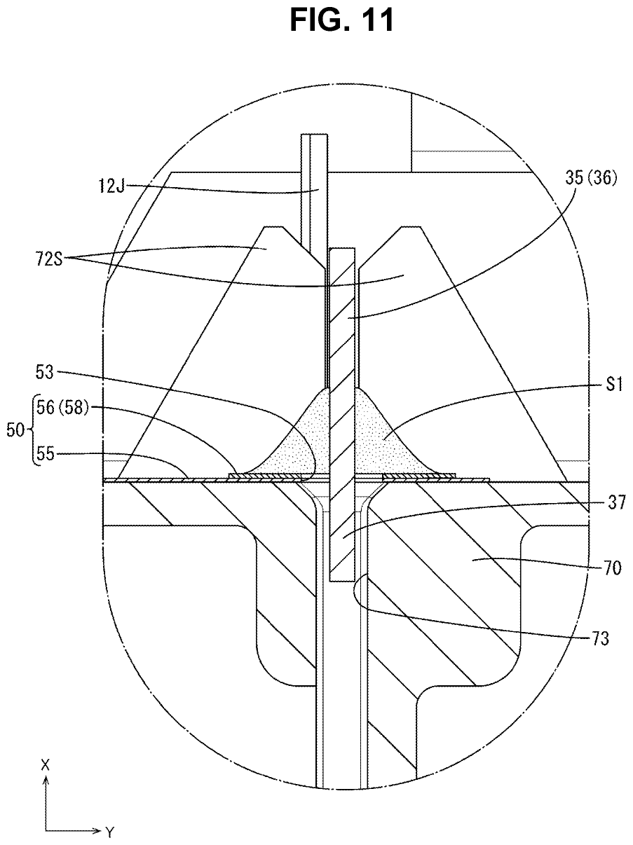

As shown in FIG. 2, the wiring modules 20 according to the present embodiment are provided with two protectors 70 that are disposed on the front and rear sides of the power storage elements 11. Each protector 70 is made of an insulative synthetic resin and has a plate shape. As shown in FIG. 3, electrode receiving portions 71 are arranged in the left-right direction at the central portion of the protector 70 in the up-down direction. The electrode receiving portions 71 extend through the protector 70 in the front-rear direction and have a rectangular shape that is elongated in the up-down direction. Groove portions 72 that hold the busbars 30 are provided on the upper side of the left and right end portions of the protector 70. Sub-terminal holding portions 72S that respectively hold the sub-terminals 35 are provided below the electrode receiving portions 71, excluding the left and right end portions of the protector 70. As shown in FIG. 11, positioning holes 73 that receive a protruding portion 37 of a sub-terminal 35 or a leading end of a busbar-side connection portion 32 of a busbar 30 are provided on the lower side of the protector 70.

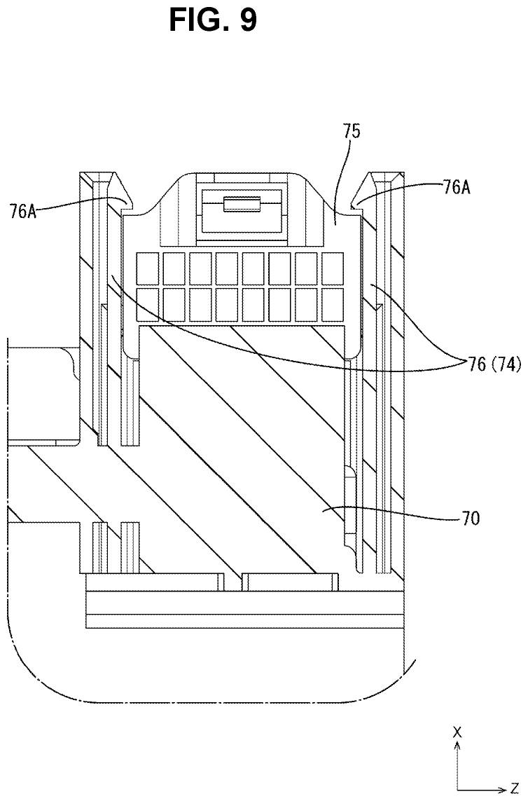

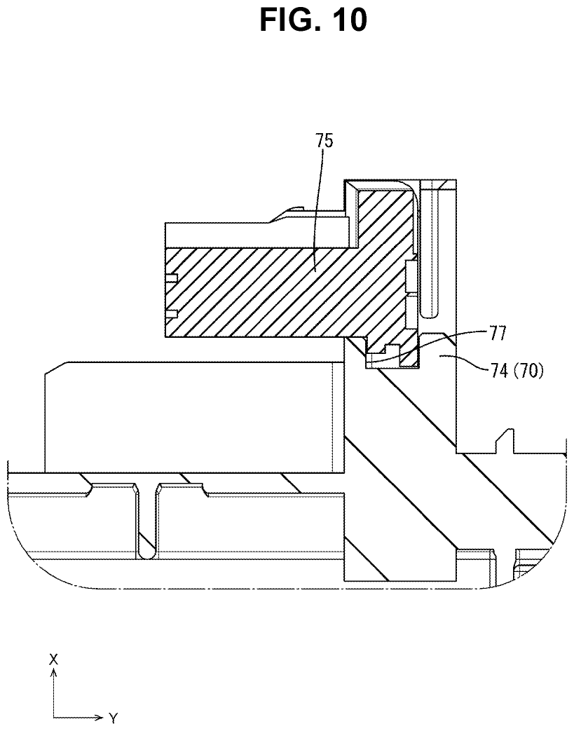

As shown in FIGS. 2 and 3, a connector holding portion 74 that protrudes forward is provided at a central position in the left-right direction on the upper side of the protector 70. The connector holding portion 74 is a member for holding a later described connector 75, and is only provided on the protector 70 disposed on the front side of the power storage elements 11. As shown in FIG. 9, the connector holding portion 74 includes a pair of elastic pieces 76 that are elastically deformable in the up-down direction, and connector locking portions 76A respectively provided on the elastic pieces 76. As shown in FIG. 10, the connector holding portion 74 has a recessed connector attachment portion 77 for attaching the connector 75.

### Electric Wire Locking Portion

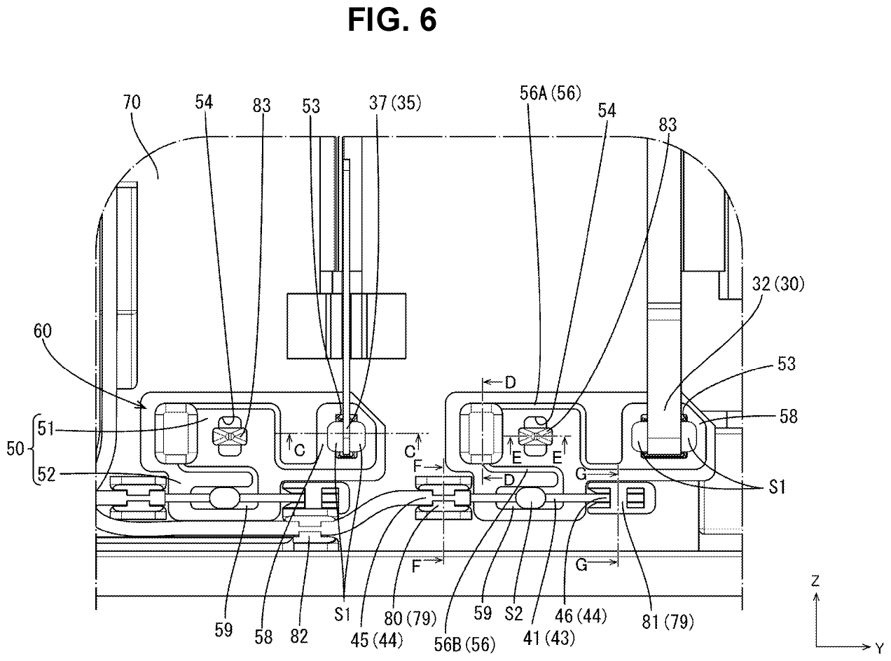

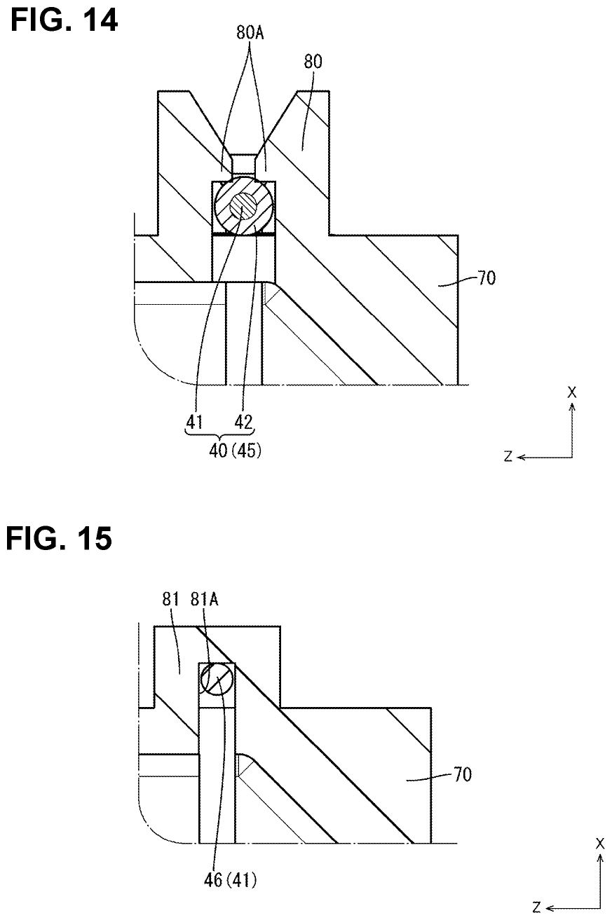

As shown in FIG. 3, a recessed routing portion 78 that extends in the up-down direction is provided slightly to the left (right side in FIG. 3) of the central position of the protector 70 in the left-right direction. The recessed routing portion 78 is formed recessed toward the power storage elements 11 (see FIG. 2), and enables the collective routing of a plurality of electric wires 40 in the up-down direction. Electric wire locking portions 79 for locking individual electric wires 40 are provided arranged in the left-right direction below the recessed routing portion 78. As shown in FIG. 6, two electric wire locking portions 79 are provided on a later-described electric wire land 59 of the circuit board 50, and are disposed on two sides of the electric wire land 59 in the left-right direction. One of the electric wire locking portions 79 located on two sides of the electric wire land 59 is a first electric wire locking portion 80 and the other is a second electric wire locking portion 81. As shown in FIG. 14, the first electric wire locking portion 80 has a pair of locking claws 80A that are disposed facing each other in the up-down direction. As shown in FIG. 15, the second electric wire locking portion 81 has an insertion hole 81A extending therethrough in the left-right direction (the direction perpendicular to the sheet).

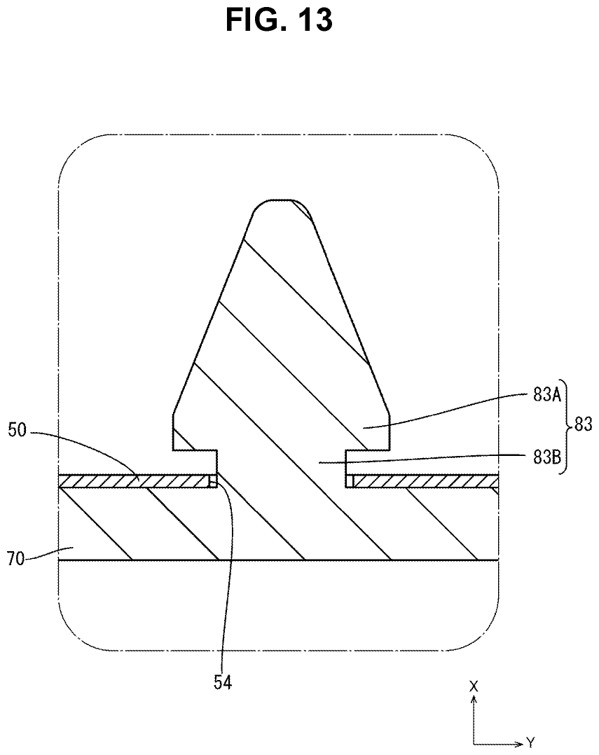

As shown in FIG. 3, routing locking portions 82 also used in the routing of the electric wires 40 are arranged in the left-right direction below the electric wire locking portions 79. The routing locking portions 82 have similar shapes to the first electric wire locking portions 80. As shown in FIG. 6, a board locking portion 83 protruding forward is provided on the upper side of an intermediate position between the first electric wire locking portion 80 and the second electric wire locking portion 81. As shown in FIG. 13, the board locking portion 83 has a protrusion shape, and the outer diameter of an umbrella portion 83A forming the leading end thereof is larger than that of a shaft portion 83B on the base end side of the board locking portion 83.

### Sub-Terminal

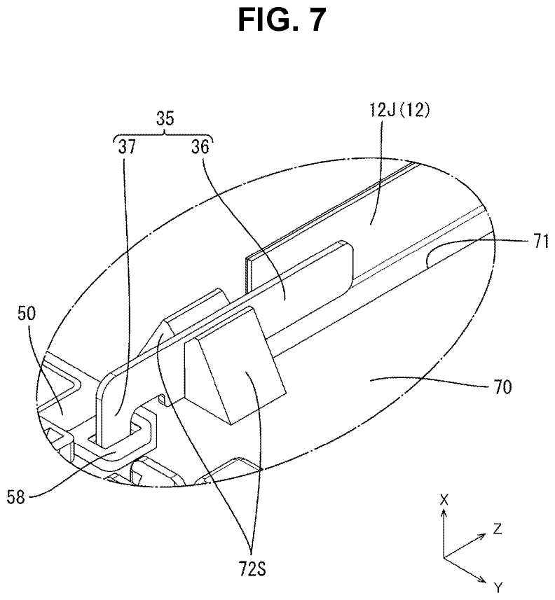

As shown in FIG. 7, the sub-terminal 35 is a metal plate-shaped member. The sub-terminal 35 has an L shape as seen in a plate thickness direction thereof, and has a sub-terminal body portion 36 that extends in the up-down direction, and a protruding portion 37 that protrudes rearward. The sub-terminal 35 is held by a sub-terminal holding portion 72S of the protector 70 so that the plate thickness direction thereof matches the left-right direction. The upper end portion of the sub-terminal body portion 36 is overlapped with the joining portion 12J and is welded thereto through laser welding. The protruding portion 37 is inserted into a connection hole 53 of the circuit board 50 where it is soldered to a connector land 58 (see FIG. 11).

As shown in FIG. 7, the sub-terminal 35 is disposed so as not to be sandwiched between two electrode terminals 12 forming the joining portion 12J, and is connected to the joining portion 12J or at least one electrode terminal 12 forming the joining portion 12J. That is, the sub-terminal 35 is not a member for connecting adjacent electrode terminals 12 to each other, but is instead a member for connecting electrode terminals 12 connected in advance (joining portion 12J) and the circuit board 50 to each other. Thus, the sub-terminal 35 does not need to be connected to the joining portion 12J (electrode terminal 12) over the entire width of the electrode terminal 12 in the up-down direction.

### Busbar

Each busbar 30 has a plate shape and is formed by processing a conductive metal plate. As shown in FIG. 3, the busbars 30 are respectively held by the groove portions 72 of the protector 70 such that the plate-thickness direction thereof matches the left-right direction. The central portion of each busbar 30 is a busbar body portion 31 to which the corresponding end portion electrode terminal 12E is connected. The lower portion of the busbar 30 is provided with a busbar-side connection portion 32. As shown in FIG. 6, the busbar-side connection portion 32 is inserted into the connection hole 53 of the circuit board 50 where it is connected to the connection land 58 by solder S1. The leading end of the busbar-side connection portion 32 inserted into the connection hole 53 is received by the positioning hole 73 and positioned relative to the protector 70 in a manner similar to the protruding portion 37 of the sub-terminal 35 shown in FIG. 11.

As shown in FIG. 2, when attaching the wiring module 20 to the front side of the power storage elements 11, the end portion electrode terminals 12E and the joining portions 12J are inserted into the electrode receiving portions 71 of the protector 70. When connecting the end portion electrode terminal 12E and the busbar body portion 31 to each other, the end portion electrode terminal 12E is bent appropriately so as to abut against the busbar body portion 31.

### Circuit Board and Locking Hole

As shown in FIG. 6, each circuit board 50 has a rectangular body portion 51 and a protrusion portion 52 provided so as to protrude downward from the body portion 51. The body portion 51 is provided with the connection hole 53 into which the busbar-side connection portion 32 of the busbar 30 or the protruding portion 37 of the sub-terminal 35 is inserted, and a locking hole 54 into which a board locking portion 83 of the protector 70 is inserted. Here, the inner wall of the locking hole 54 is an example of a locked portion. That is, the inner wall of the locking hole 54 is locked to the board locking portion 83, and thus the circuit board 50 is assembled to the protector 70. The connection hole 53 is disposed near the outer edge of the body portion 51, and the locking hole 54 is disposed at the center of the body portion 51. The same number of circuit boards 50 of the present embodiment as the total number of busbars 30 and sub-terminals 35 is provided.

### Conductive Path

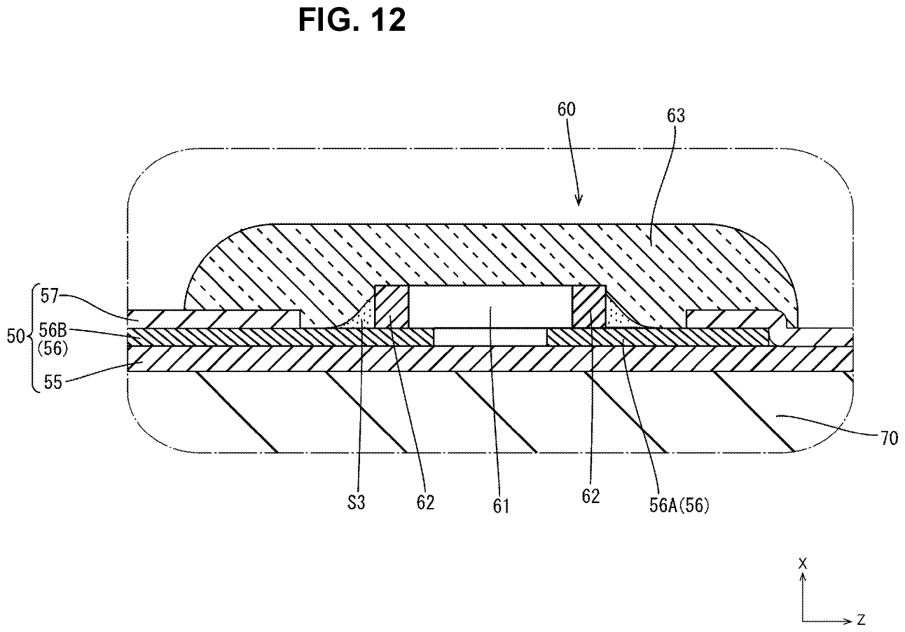

The circuit board 50 of the present embodiment is a flexible printed circuit board that has flexibility, and as shown in FIG. 12, includes a base film 55, a conductive path 56 routed on the surface of the base film 55, and a coverlay film 57 that covers the conductive path 56. The base film 55 and the coverlay film 57 are made of a synthetic resin that has insulative properties and is flexible, such as polyimide. The conductive path 56 is made using a copper, copper-alloy foil, or the like. As shown in FIG. 6, the conductive path 56 includes the connection land 58 to which the busbar 30 or the sub-terminal 35 is connected, the electric wire land 59 to which the electric wire 40 is connected, and a fuse portion 60 provided between the connection land 58 and the electric wire land 59.

### Connection Land and Electric Wire Land

As shown in FIGS. 6 and 11, the connection land 58 is formed around the connection hole 53, and is disposed at one end of the conductive path 56. The connection land 58 is electrically connected to the busbar-side connection portion 32 of the busbar 30 or the protruding portion 37 of the sub-terminal 35 inserted into the connection hole 53, using the solder S1. As shown in FIG. 6, the electric wire land 59 is provided at the center of the protrusion portion 52 and is disposed at the other end of the conductive path 56. The electric wire land 59 is electrically connected to a core wire 41 of the electric wire 40 disposed across the protrusion portion 52 in the left-right direction, using solder S2.

### Fuse Portion, Chip Fuse, and Insulating Resin

As shown in FIG. 6, the fuse portion 60 is provided at an intermediate portion of the conductive path 56 between the connection land 58 and the electric wire land 59. As shown in FIG. 12, the fuse portion 60 of the present embodiment has a chip fuse 61, and the chip fuse 61 and the conductive path 56 are connected to each other by solder S3. Specifically, one of two electrodes 62 of the chip fuse 61 is connected to a conductive path 56A on the connection land 58 side, and the other is connected to a conductive path 56B on the electric wire land 59 side (see FIG. 6).

By providing the fuse portion 60, even if an issue occurs in an external circuit connected to the power storage module 10 that causes conductive paths 56 to short-circuit resulting in an overcurrent, the chip fuse 61 melts, and thus it is possible to restrict the overcurrent from flowing from a power storage element 11 to a conductive path 56.

As shown in FIG. 12, in the present embodiment, the connection portion between the chip fuse 61 and the conductive path 56 is covered by insulating resin 63. Here, the connection portion between the chip fuse 61 and the conductive path 56 includes at least the entire chip fuse 61, the solder S3, and portions not covered by the cover lay film 57 that are end portions of the conductive path 56 connected to the electrodes 62 of the chip fuse 61. The insulating resin 63 covers the connection portion between the chip fuse 61 and the conductive path 56, and thus, even if water droplets or the like caused by condensation form on the circuit board 50, it is possible to suppress short-circuiting of the conductive path 56.

### Electric Wire, One End of Electric Wire, and Other End of Electric Wire

As shown in FIG. 14, the electric wire 40 has the core wire 41, and the insulating coating 42 that covers the core wire 41. As shown in FIG. 3, the end portion of each electric wire 40 disposed on the lower side of the protector 70 is one end 43 of the electric wires 40. Each end portion on the side opposite to the one end 43 of the electric wires 40 is another end 47 of the electric wires and is connected to the connector 75. As shown in FIG. 6, the one end 43 of the electric wire 40 is connected to the electric wire land 59 of the circuit board 50. Electric wire locked portions 44 that are locked by the electric wire locking portions 79 of the protector 70 are provided on two sides of the core wire 41 connected to the electric wire land 59, at the one end 43 of the electric wire 40. The electric wire locked portion 44 disposed on the other end 47 side of the electric wire 40 (i.e., the connector 75 side) is a first electric wire locked portion 45, and the other is a second electric wire locked portion 46. As shown in FIG. 14, the first electric wire locked portion 45 is locked by locking claws 80A of a first electric wire locking portion 80. The first electric wire locked portion 45 includes the insulating coating 42, and thus damage to the core wire 41 of the first electric wire locked portion 45 caused by the locking claws 80A is suppressed. Thus, electrical connection between the connector 75 and the electric wire land 59 is not impaired.

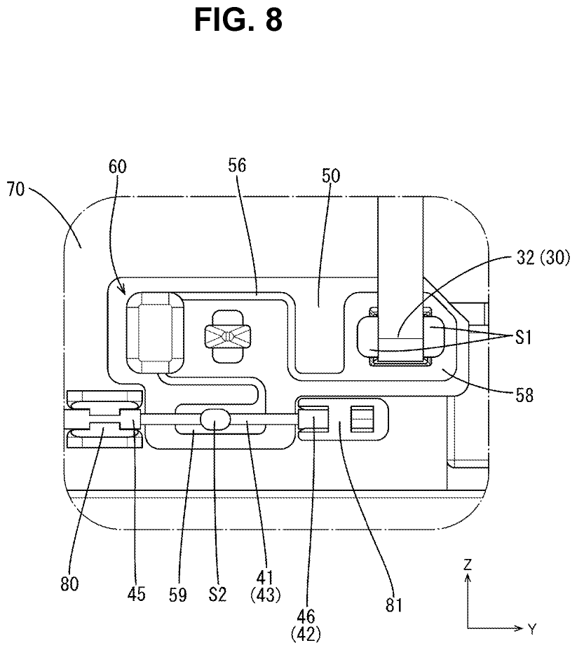

As shown in FIG. 15, the second electric wire locked portion 46 can be formed by the core wire 41 alone, and is inserted into an insertion hole 81A of the second electric wire locking portion 81. When the core wire 41 is constituted by a plurality of bare strands, it is preferable to coat the core wire 41 of the second electric wire locked portion 46 with solder or the like. Accordingly, the bare strands do not spread apart, and thus the second electric wire locking portion 81 can easily lock the second electric wire locked portion 46. Also, even if the second electric wire locked portion 46 is configured to include the insulating coating 42, as shown in FIG. 8, similar effects can be obtained.

As shown in FIG. 3, the electric wires 40 are routed at a predetermined position of the protector 70 by the recessed routing portion 78 and the routing locking portions 82. Thus, connection between the one ends 43 of the electric wires 40 and the circuit boards 50 is unlikely to be hampered by other electric wires 40.

As shown in FIGS. 2 and 3, a portion of the electric wires 40 drawn from the connector 75 are routed rearward on the upper surface of the power storage elements 11, and connected to a circuit board 50 disposed on the rear side of the power storage elements 11 in a similar fashion to that described above. Thus, in the present embodiment, since the wiring modules 20 attached to the front and rear of the power storage elements 11 are configured by routing long electric wires 40 in the front-rear direction, the manufacturing cost of the wiring module 20 can be reduced compared to a case where a similar wiring module is formed using circuit boards and not using electric wires, for example.

### Connector

The connector 75 is made of an insulative synthetic resin and has a block shape, as shown in FIG. 2. As shown in FIG. 10, the connector 75 is attached to the recessed connector attachment portion 77, and does not move in the left-right direction. As shown in FIG. 9, the connector 75 is locked from above by the connector locking portions 76A, and is thus held by the protector 70. A female terminal (not shown) is housed inside the connector 75. As shown FIG. 3, the electric wires 40 connected to the female terminal are drawn out from the left side of the connector 75. A partner connector (not shown) including a male terminal is fitted to the connector 75 from the right side. The partner connector is connected to an external ECU (Electronic Control Unit) or the like via an un-shown electric wire. The ECU is a unit to which a micro-computer, an element, or the like is mounted, and has a known configuration provided with functions including detecting the voltage, current, temperature and the like of the power storage elements 11, and controlling charging/discharging of the power storage elements 11.

In the present embodiment, as shown in FIG. 6, the circuit board 50 is formed with the minimum required dimensions for providing the connection land 58, the fuse portion 60, and the electric wire land 59. Also, as shown in FIG. 3, cheap electric wires 40 are used as conductors that are routed on the protector 70 and connect the connector 75 and the circuit boards 50 to each other. With such a configuration, electrical connection of the busbars 30 and formation of the fuse portions 60 can be more favorably achieved using the circuit boards 50, and the amount of circuit boards 50 used on the wiring module 20 can be reduced. Thus, it is possible to suppress an increase in the manufacturing cost of the wiring module 20 incurred by imparting a fuse function.

The present embodiment is configured as described above, and an assembly example of the wiring module 20 is illustrated below.

First, the circuit board 50 provided with the fuse portion 60 in advance is assembled to the protector 70. The umbrella portion 83A of the board locking portion 83 is inserted into the locking hole 54 of the circuit board 50, and the circuit board 50 is shaft-supported by the shaft portion 83B (see FIG. 13). By providing the protrusion portion 52 between the electric wire locking portions 79 and matching the connection hole 53 with the positioning hole 73, the circuit board 50 is disposed at a predetermined position of the protector 70 (see FIG. 6). A flexible printed circuit board that has flexibility is employed as the circuit board 50, and thus the circuit board 50 can be easily assembled to the protector 70.

The sub-terminal 35 is assembled to the protector 70. The sub-terminal 35 is inserted into the sub-terminal holding portion 72S (see FIG. 7), while the protruding portion 37 is inserted into the connection hole 53 and inserted into the positioning hole 73 (see FIG. 11). Next, the protruding portion 37 and the connection land 58 are soldered to each other. Similarly, after the busbar 30 is inserted into the groove portion 72, and the busbar-side connection portion 32 is inserted into the connection hole 53 and the positioning hole 73, the busbar-side connection portion 32 and the connection land 58 are soldered to each other.

Next, the connector 75 to which the electric wires 40 are connected is attached to the connector holding portion 74 of the protector 70. When the left portion of the connector 75 is pressed rearward toward the connector holding portion 74 from the front, the elastic pieces 76 flex, and the connector 75 is housed in the recessed connector attachment portion 77, and the connector 75 is locked from above by the connector locking portions 76A (see FIGS. 9 and 10). Then, the electric wires 40 are routed at predetermined positions of the protector 70 (see FIG. 3). Lastly, once the electric wire locking portions 79 have locked the electric wire locked portions 44 of the electric wires 40, and the core wires 41 are soldered to the electric wire lands 59, assembly of the wiring module 20 is complete (see FIG. 6).

Note that, regarding the process of routing the electric wires 40 on the protector 70 and the process of soldering the electric wires 40 to the electric wire lands 59, it is also conceivable to perform these processes after attaching the protectors 70 to the front and rear of the power storage elements 11 and connecting the electrode terminals 12 to the busbars 30 or the sub-terminals 35. This is because, if, for example, the power storage elements 11 are extremely long, the fully assembled wiring module 20 is difficult to handle.

### Operation and Effects of Embodiment 1

The following operation and effects are exhibited with Embodiment 1. The wiring module 20 according to Embodiment 1 is attached to the power storage elements 11, and includes the circuit boards 50, the electric wires 40, and the protector 70 that holds the circuit boards 50 and the electric wires 40. The conductive paths 56 are respectively routed on the circuit boards 50, and each conductive path 56 includes the connection land 58 electrically connected to the electrode terminals 12 of a plurality of power storage elements 11, the electric wire land 59 connected to one end 43 of the electric wire 40, and the fuse portion 60 provided between the connection land 58 and the electric wire land 59.

With the above configuration, the wiring module 20 is provided with the circuit boards 50 including the fuse portions 60, and the electric wires 40 are used together with the circuit boards 50, and thus the amount of circuit boards 50 used can be reduced. Accordingly, it is possible to suppress an increase in the manufacturing cost of the wiring module 20 and provide the fuse portions 60 in the wiring module 20.

In Embodiment 1, the power storage elements 11 are laminated batteries, and a plurality of power storage elements 11 are provided with joining portions 12J where electrode terminals 12 of adjacent laminated batteries are electrically connected to each other.

With the above configuration, a member for connecting adjacent electrode terminals 12 of the power storage elements 11 does not need to be provided on the wiring module 20.

The wiring module 20 of Embodiment 1 includes the sub-terminals 35 that electrically connect the electrode terminals 12 and the connection lands 58 to each other, correspondingly.

With the above configuration, the electrode terminals 12 and the connection lands 58 can be easily electrically connected to each other. Also, the amount of circuit boards 50 used can be reduced.

The wiring module 20 according to Embodiment 1 is disposed on two end portions of the power storage elements 11, and includes two busbars 30 that connect the electrode terminals 12 that do not form the joining portions 12J and the corresponding connection lands 58.

With the above configuration, the busbars 30 can be used to configure the positive and negative electrodes of the power storage elements 11 as a whole.

In Embodiment 1, the protector 70 includes the electric wire locking portions 79 that lock the electric wires 40.

With the above configuration, the electric wires 40 can be locked to the protector 70.

In Embodiment 1, two of the electric wire locking portions 79 are provided on each electric wire land 59, and are disposed on two sides of the electric wire land 59.

With the above embodiment, the electric wire 40 and the electric wire land 59 can be easily electrically connected to each other.

In Embodiment 1, the circuit board 50 has the locking hole 54, and the protector 70 is provided with the board locking portion 83 that locks to the inner wall of the locking hole 54.

With the above configuration, the circuit board 50 can be locked to the protector 70.

The wiring module 20 according to Embodiment 1 includes the connector 75 to which the other ends 47 of the electric wires 40 are connected, and the connector 75 is held by the protector 70.

With the above configuration, electric signals from the power storage elements 11 can be transmitted to an external device via the connector 75.

In Embodiment 1, the fuse portion 60 is constituted by the chip fuse 61 connected to the conductive path 56 of the circuit board 50 by the solder S3.

With the above configuration, when an overcurrent flows through the conductive path 56, the chip fuse 61 melts, and thus the conductive path 56 can be protected from the overcurrent.

The wiring module 20 according to Embodiment 1 is a wiring module 20 attached to the front and rear sides of the power storage elements 11 that are elongated in the front-rear direction, and includes the electric wires 40 that extend routed in the front-rear direction.

With the above configuration, the wiring module 20 includes the electric wires 40 that extend routed in the front-rear direction, and thus the manufacturing cost of the wiring module 20 can be reduced.

### Embodiment 2

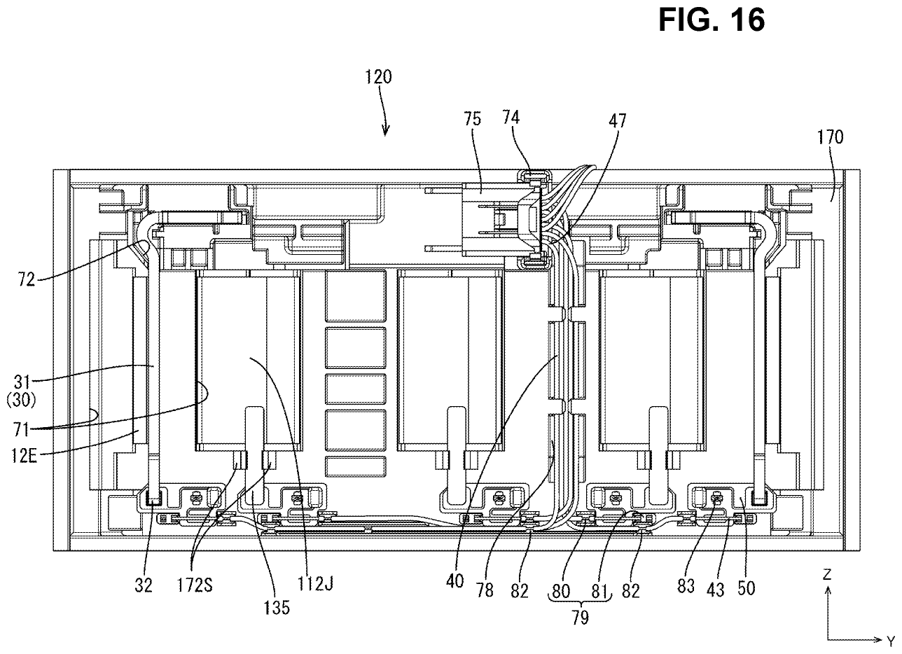

Embodiment 2 of the present disclosure will be described with reference to FIGS. 16 to 18. A wiring module 120 according to Embodiment 2 has the same configuration as that of the wiring module 20 of Embodiment 1, apart from the configurations of joining portions 112J of the power storage elements 11 and sub-terminal 135. Below, members that are the same as those in Embodiment 1 are given the symbols used in Embodiment 1, and description of configurations, operation, and effects that are the same as those of Embodiment 1 are omitted.

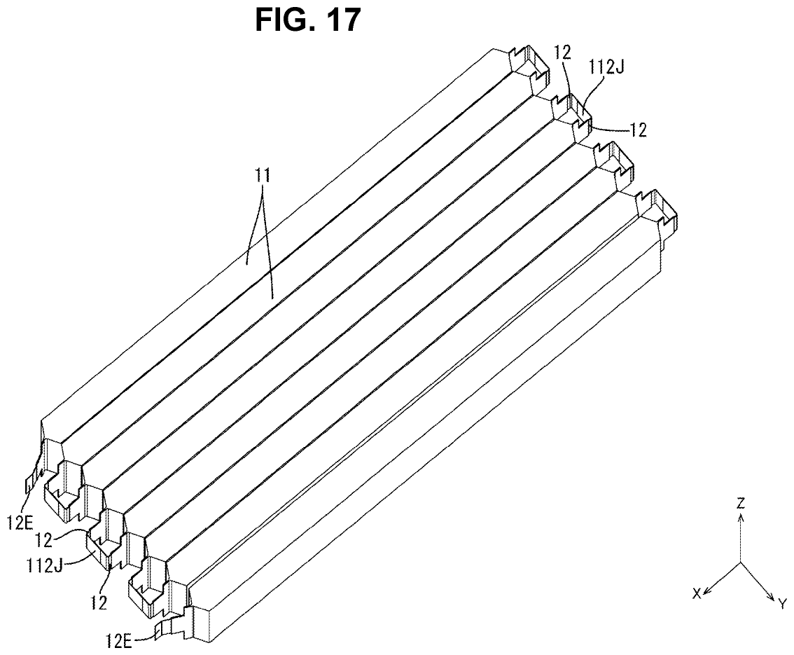

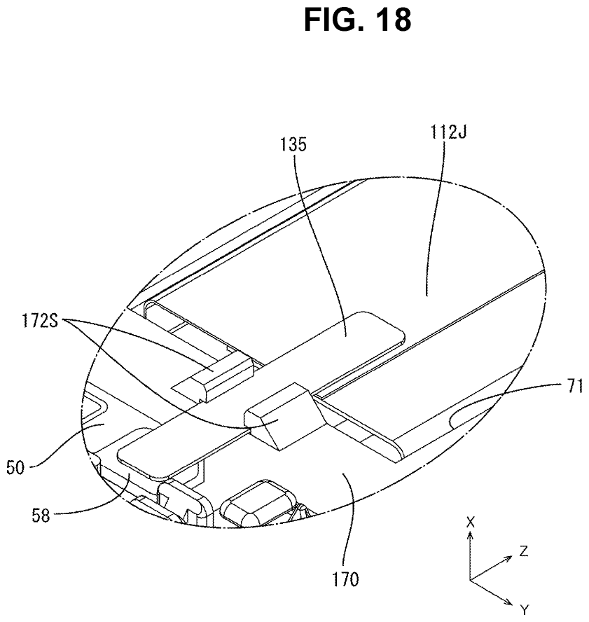

As shown in FIG. 17, the power storage elements 11 of the present embodiment are formed by laminated batteries similar to Embodiment 1, and include the joining portions 112J. Each joining portion 112J is formed by bending adjacent electrode terminals 12 left or right at 90°, overlapping the folded portions, and joining the overlapped portions through laser welding. Specifically, the joining portions 112J are disposed orthogonal to the left and right side surfaces of the power storage elements 11. As shown in FIG. 16, an electrode receiving portion 71 into which a joining portion 112J is inserted is larger in the left-right direction compared to Embodiment 1.

As shown in FIG. 18, the sub-terminal 135 is a metal plate-shaped member, and has an elongated shape in the up-down direction. The sub-terminal 135 is held by sub-terminal holding portions 172S of a protector 170 such that the plate thickness direction thereof matches the front-rear direction. The sub-terminal 135 is disposed in surface contact with the protector 170, and thus can be easily held by the protector 170. The upper end portion of the sub-terminal 135 is connected to the joining portion 112J through laser welding. The lower end portion of the sub-terminal 135 is soldered to the connection land 58 of the circuit board 50. Note that, in the present embodiment, the sub-terminal 135 and the connection land 58 are positioned to be in surface contact via solder, and thus the connection hole 53 and the positioning hole 73 (see FIG. 11) do not need to be provided for the sub-terminal 135.

### Embodiment 3

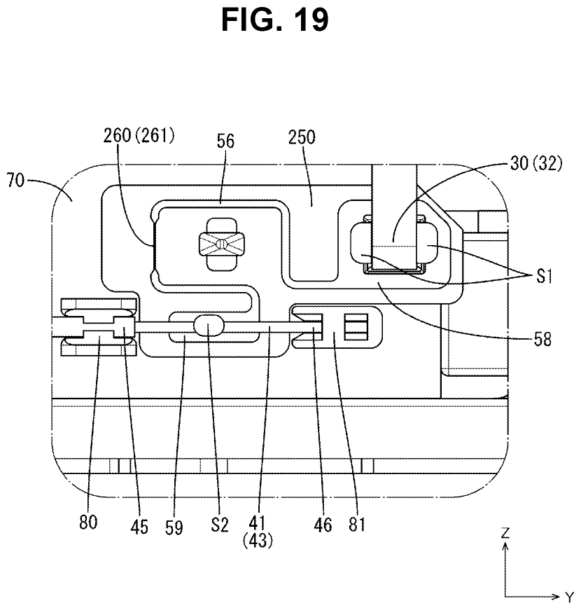

Embodiment 3 of the present disclosure will be described with reference to FIG. 19. The configuration of Embodiment 3 is the same as the configuration of Embodiment 1, apart from a fuse portion 260. Below, members that are the same as those in Embodiment 1 are given the symbols used in Embodiment 1, and description of configurations, operation, and effects that are the same as those of Embodiment 1 are omitted.

As shown in FIG. 19, a circuit board 250 according to Embodiment 3 includes the fuse portion 260. The fuse portion 260 is constituted by a pattern fuse 261 that is provided by narrowing the conductive path 56. The circuit board 250 is a thin flexible printed circuit board, and is configured so that heat is less likely to escape from the circuit board 250 in the thickness direction thereof, compared to a case where a thick and hard circuit board or the like is used. The pattern fuse 261 is thin, and thus generates heat and melts when an overcurrent flows therethrough, therefore an overcurrent can be restricted from flowing through the conductive path 56.

In the present embodiment, in the process of manufacturing an ordinary flexible printed circuit board, the pattern fuse 261 (fuse portion 260) can be formed when forming the conductive path 56. Accordingly, the process of forming the fuse portion 60 in Embodiment 1, that is, the process of connecting the chip fuse 61 to an end portion of the conductive path 56 can be omitted.

### Operation and Effects of Embodiment 3

The following operation and effects are exhibited with Embodiment 3.

In Embodiment 3, the circuit board 250 is a flexible printed circuit board, and the fuse portion 260 is constituted by the pattern fuse 261. With this configuration, the fuse portion 260 can be formed in the process of manufacturing the flexible printed circuit board.

### Embodiment 4

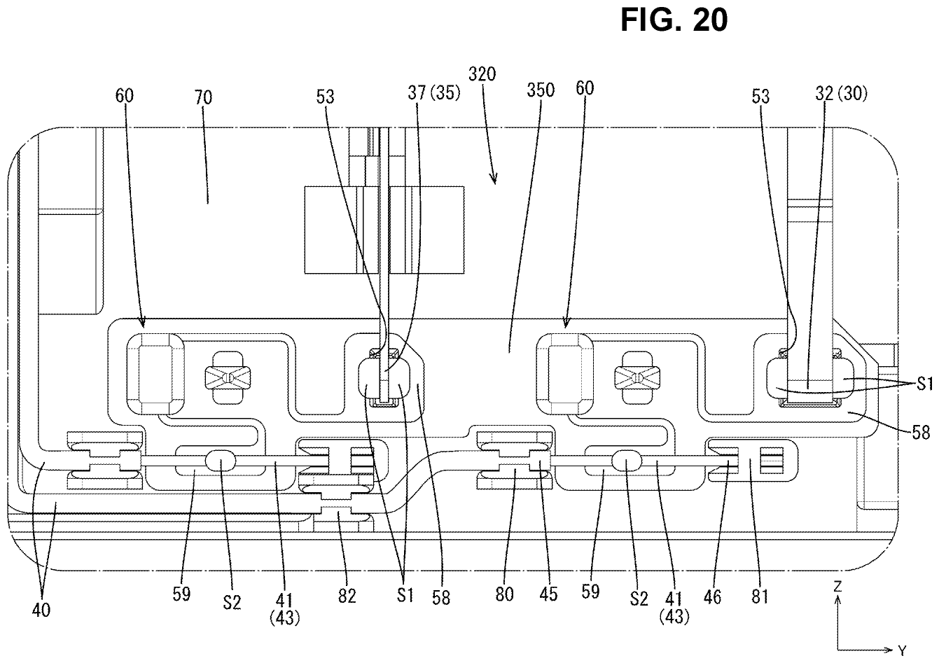

Embodiment 4 of the present disclosure will be described with reference to FIG. 20. The configuration of Embodiment 4 is the same as the configuration of Embodiment 1, apart from including a circuit board 350. Below, members that are the same as those in Embodiment 1 are given the symbols used in Embodiment 1, and description of configurations, operation, and effects that are the same as those of Embodiment 1 are omitted.

As shown in FIG. 20, a wiring module 320 according to Embodiment 4 includes a circuit board 350. The circuit board 350 has a configuration where two circuit boards 50 (see FIG. 6) of Embodiment 1 are continuous. That is, the circuit board 350 includes two each of the connection hole 53, the connection land 58, the electric wire land 59, and the fuse portion 60, to which a busbar 30, a sub-terminal 35, and two electric wires 40 are connected. Here, the circuit board 350 configured by two continuous circuit boards 50 was specifically described, but a circuit board configured by three continuous circuit boards 50 can also be employed according to the position, size, manufacturing cost, and the like of the members of the wiring module 320.

### Operation and Effects of Embodiment 4

The following operation and effects are exhibited with Embodiment 4.

The wiring module 320 according to Embodiment 4 includes the circuit board 350 provided with more than one of the connection land 58, the electric wire land 59, and the fuse portion 60.

With the above configuration, the number of circuit boards 350 used in the wiring module 320 can be reduced, and thus the assembly workability of the wiring module 320 can be made easier.

### OTHER EMBODIMENTS

(1) In the above embodiment, flexible printed circuit boards were used as the circuit boards 50, 250, and 350, but the present invention is not limited to this, and a hard printed circuit board, a flexible flat cable (FFC), or the like may be employed as the circuit board.

(2) In the above embodiment, the power storage elements 11 are laminated batteries, but the present invention is not limited to this, and various types of power storage elements can be employed.

(3) In the above embodiment, the joining portions 12J and 112J and the connection land 58 are configured to be connected via the sub-terminals 35 and 135, but the present invention is not limited to this. For example, a configuration may be employed where either one of the electrode terminals forming a joining portion and the circuit board has a shape that extends toward the other, and the two are electrically connected to each other through direct soldering or the like.

(4) In Embodiments 1, 3, and 4, a configuration is employed where the busbar-side connection portion 32 and the protruding portion 37 are inserted into the connection hole 53 and connected to the connection land 58, but the present invention is not limited to this, and a configuration is possible where the circuit board does not include a connection hole.

(5) In Embodiments 1, 2, and 4, a configuration was employed where the connection portion between the chip fuse 61 and the conductive path 56 is covered by the insulating resin 63, but the present invention is not limited to this, and a configuration is possible where the chip fuse is not covered by an insulating resin.

(6) In the above embodiment, a configuration was employed where the electric wire locking portions 79 has the first electric wire locking portion 80 and the second electric wire locking portion 81, but the present invention is not limited to this, and a configuration is possible where the electric wire locking portion only includes the first electric wire locking portion or only the second electric wire locking portion.

(7) In the above embodiment, the locked portion locked by the board locking portion 83 was the inner wall of the locking hole 54, but the present invention is not limited to this, and a configuration is possible where the locked portion is an outer edge portion of a circuit board, and a claw-shaped board locking portion is locked to the outer edge portion of the circuit board, for example.

(8) In the above embodiment, a configuration was employed where the circuit boards 50, 250, and 350 where locked to the board locking portion 83, but the present invention is not limited to this configuration, and a configuration is possible where the circuit board is held by the protector through heat crimping, use of an adhesive, or the like.

### LIST OF REFERENCE NUMERALS

1 Vehicle
2 Power storage pack
3 PCU
4 Wire harness
10 Power storage module
11 Power storage element
12 Electrode terminal
12E End portion electrode terminal
12J, 112J Joining portion
20, 120, 320 Wiring module
30 Busbar
31 Busbar body portion
32 Busbar-side connection portion
35, 135 Sub-terminal
36 Sub-terminal body portion
37 Protruding portion
40 Electric wire
41 Core wire
42 Insulating coating
43 One end of electric wire
44 Electric wire locked portion
45 First electric wire locked portion
46 Second electric wire locked portion
47 Other end of electric wire
50, 250, 350 Circuit board
51 Body portion
52 Protrusion portion
53 Connection hole
54 Locking hole
55 Base film
56 Conductive path
56A Conductive path on connection land side
56B Conductive path on electric wire land side
57 Coverlay film
58 Connection land
59 Electric wire land
60, 260 Fuse portion
61 Chip fuse
62 Electrode
63 Insulating resin
70, 170 Protector
71 Electrode receiving portion
72 Groove portion
72S, 172S Sub-terminal holding portion
73 Positioning hole
74 Connector holding portion
75 Connector
76 Elastic piece
76A Connector locking portion
77 Recessed connector attachment portion
78 Recessed routing portion
79 Electric wire locking portion
80 First electric wire locking portion
80A Locking claw
81 Second electric wire locking portion
81A Insertion hole
82 Routing locking portion
83 Board locking portion
83A Umbrella portion
83B Shaft portion
261 Pattern fuse
S1, S2, S3 Solder

1. A wiring module that is attached to a plurality of power storage elements, comprising:
a circuit board;
an electric wire; and
a protector configured to hold the circuit board and the electric wire,
wherein a conductive path is routed on the circuit board, and
the conductive path includes a connection land that is electrically connected to an electrode terminal of a power storage element among the plurality of power storage elements, an electric wire land that is connected to one end of the electric wire, and a fuse portion provided between the connection land and the electric wire land.

2. The wiring module according to claim 1,
wherein each of the power storage elements is a laminated battery, and
the plurality of power storage elements are provided with a joining portion where the electrode terminals of the adjacent laminated batteries are electrically connected to each other.

3. The wiring module according to claim 2, further comprising
a sub-terminal that electrically connects the electrode terminal and the connection land to each other.

4. The wiring module according to claim 2, further comprising
two busbars each configured to connect a corresponding connection land to a corresponding one of the electrode terminals that are provided at two end portions of the plurality of power storage elements and do not form the joining portion.

5. The wiring module according to claim 1,
wherein the protector includes an electric wire locking portion configured to lock the electric wire.

6. The wiring module according to claim 5,
wherein two of the electric wire locking portions are provided on each electric wire land, and are disposed on two sides of the electric wire land.

7. The wiring module according to claim 1,
wherein the circuit board includes a locked portion, and
the protector includes a board locking portion configured to lock the locked portion.

8. The wiring module according to claim 1, further comprising
a connector connected to another end of the electric wire,
wherein the connector is held by the protector.

9. The wiring module according to claim 1,
wherein the fuse portion is constituted by a chip fuse that is soldered to the conductive path of the circuit board.

10. The wiring module according to claim 1,
wherein the circuit board is a flexible printed circuit board, and
the fuse portion is constituted by a pattern fuse.

11. The wiring module according to claim 1, including
the circuit board provided with more than one of each of the connection land, the electric wire land, and the fuse portion.

12. The wiring module according to claim 1 is a wiring module that is attached to the front and rear of the plurality of power storage elements that are elongated in a front-rear direction, and
includes the electric wire routed extending in the front-rear direction.

13. The wiring module according to claim 1 is a vehicle wiring module to be used mounted in a vehicle.
